(19) United States
(12) Patent Application Publication
(10) Pub. No.: US 2002/0118425 A1
(43) Pub. Date: Aug. 29, 2002

(54) Fiber path redundancy and narrowcast operation

(76) Inventors: Donald C. Dove, Kent, WA (US); Richard Joe Blount, JR., Federal Way, WA (US); Simon Clive Hughes, Bellevue, WA (US)

Correspondence Address: BLACK LOWE & GRAHAM, 816 SECOND AVE., SEATTLE, WA, 98104, US

(21) Appl. No.: 09/794,902

(22) Filed: Feb. 26, 2001

(51) Int. Cl. H04J 14/00; H04B 10/06

(52) U.S. Cl. 359/189; 359/117

(57) ABSTRACT

A system and method for receiving and transmitting data signals over an optical receiver module with fiber path redundancy and narrowcast operation. An optical receiver receives the data transmitted over a network of fiber cables. The optical receiver includes a plurality of photodiodes for converting the optical signal to a RF signal and for sensing the quality of the optical signal. When the quality of the signal is determined to be outside a threshold range, one of the plurality of photodiodes sends an alarm signal monitored by a module microcontroller connected to the optical receiver module. Additionally, the alarm signal is sent to a remote operator. The module microcontroller analyzes the alarm signal and outputs a logical command stored in the memory of the module microcontroller to switch via a RF relay switch, the optical-to-RF path. The logical commands include redundant and narrowcast service path switching logic. The remote operator can manually force the switching of the optical-to-RF path or narrowcast services path.

### FIELD OF THE INVENTION

This invention relates to an improved system and method for receiving and transmitting data signals over an optical receiver with fiber path redundancy and narrowcast operation.

### BACKGROUND OF THE INVENTION

In recent years, the Cable Television (“CATV”) industry has been extending its traditional mandate by providing new television-based entertainment applications to an increasing number of subscribers. The new applications include, for example, broadband telecommunications, interactive multimedia, and video on demand (“VOD”). Each of these applications is capable of incorporating specific end-user services, also known as narrowcast services. As the variety of new applications and the number of subscribers continues to increase, the distribution systems for CATV plants (the physical implementation of the system) must be continually modified and upgraded. This growth requires that the CATV equipment be rapidly configurable and reliable. These requirements, in turn, have necessitated changes in the implementation of distribution systems from all-coaxial tree-and-branch architecture to an optical node design used, for example, with fiber optic networks, as well as increased attempts to improve system reliability through the use of redundant systems in the distribution plant.

Optical nodes are the point of connection and conversion between the fiber optic cable and coaxial cable within a distributed network. The data from the head-end service provider is usually sent over the fiber cable of the network to a plurality of preconfigured optical nodes for broadcast via the coaxial cable into a plurality of homes serviced by each of the optical nodes on the network. Depending on network architecture, each optical node has a plurality of ports for providing a direct connection between the optical node and the external network for converting an optical signal back to a Radio Frequency (“RF”) signal for distribution in the CATV coaxial plant.

Optical nodes typically include as major components a variety of electronic modules such as an optical receiver that receives information-modulated light from an optical fiber and converts that information via an integrated photodiode into an electrical signal; an optical transmitter that converts electrical signals that originate from the subscriber to information-modulated optical signals that are transported by optical fiber to a central location; an RF amplifier that provides additional gain and filtering for the electrical signals for distribution to subscribers; and a power supply which receives AC/DC electrical power for the optical node from the main cable or through a dedicated power line.

In operation, the optical receiver typically receives the optical signal through a single optical signal path. After the photodiode converts the signal to an RF signal, the signal is sent through a single RF out path to be further controlled (for example amplified) before being transmitted to the subscribers.

Existing optical nodes are configured such that the various electronic modules are fixed into specific slots in the node. The most prevalent optical node configuration in the market today has a total of four to six RF ports on the left and right sides of the optical node. A single RF amplifier module services all of the RF ports. One of the limitations of this configuration is that in the event of a failure of the circuitry driving one of the four ports, all four ports need to be removed from service to replace the offending RF amplifier module.

Existing attempts to address this failure problem have included building fiber path redundancy into the optical node. The redundant fiber paths employed today, however, typically rely on a costly RF amplifier module, which require excessively high power to maintain. As CATV delivery systems are increasingly under industry pressure to be more cost effective, the cost of redundant build out must be controlled. Additionally, as reliability becomes increasingly important to be competitive with other telecommunication service providers, redundant features become mission critical. Another critical shortcoming with typical optical node implementation relates to the inability of the system operators to cost effectively monitor the RF features and remotely configure the RF path to effectuate the redundant features of the optical node. Existing solutions rely on adding expensive electronic modules or whole nodes to effectuate redundant monitoring and remote configuration of the RF path. This solution is expensive and requires excessive DC power and signal wiring.

Yet another limitation of the current optical node design relates to the provision of narrowcast services. CATV operators typically implement narrowcast services by adding electronic modules to an optical node tasked to provide particular narrowcast services. Like the redundancy limitations noted above, this solution is expensive and requires excessive DC power.

The present invention addresses inherent problems with current optical node redundancy features and presents the solution in an optical receiver that is simple and inexpensive to deploy, monitor and effectuate.

### SUMMARY OF THE INVENTION

The present invention is an improved system and method for fiber path redundancy and narrowcast operation. The system includes an optical receiver with photodiodes for converting an optical signal of the fiber path into an electrical signal (optical-to-RF signal path), a module microcontroller for sensing and monitoring electronic functions of the optical signal, and a relay switch which, based on switching logic circuitry, switches between RF signal paths and narrowcast service.

In accordance with other aspects of the invention, the photodiodes, the relay switch and the module microcontroller are connected via a system bus circuit. The system bus circuit provides the routing, sensing and monitoring functions of the optical and RF signals.

In accordance with still further aspects of the invention, each photodiode includes an optical level sense and alarm circuit based on the DC current of each optical signal that passes through the photodiode.

In accordance with other aspects of the invention, the module microcontroller includes a microcontroller and memory for storing, sensing and monitoring electronic functions of the optical receiver. The module microcontroller monitors the photodiode DC current and determines the appropriate RF signal path based on stored logic.

In accordance with yet other aspects of the invention, the functions of the module microcontoller are incorporated directly on the relay switch.

In accordance with other aspects of the invention, the module microcontroller includes switching override outputs for manually overriding the relay switch. The remote operator can optionally choose to override any automatic switching done by the relay switch.

In accordance with other aspects of the invention, the converted optical signals are Radio Frequency (“RF”) electronic signals for distribution to subscribers of the narrowcast services.

In accordance with still further aspects of the invention, the optical receiver with a plurality of photodiodes, a module microcontroller, a relay switch coupled to the fiber path of the distribution network receives an optical signal. The optical signal's current is monitored and sensed by the module microcontroller. When the monitored current of the optical signal is above or below a predetermined optimal signal current, an alarm is triggered. The module microcontroller then outputs the logical command for switching the RF signal to an alternate path that is operating within the optimal signal current. The relay switch then switches to the optimal RF signal path.

In still further aspects of the invention, a remote operator manually overrides the RF relay switch. The remote operator can force the RF relay switch to receive the RF signal from any available path.

In yet still further aspects of the invention, the module microcontroller outputs a logical command to switch the fiber path to narrowcast services. The RF relay switches the RF path to the narrowcast path.

### BRIEF DESCRIPTION OF THE DRAWINGS

The many features and advantages of this invention are better understood with reference to the following detailed description of the preferred embodiment, along with the following drawings.

FIG. 1 illustrates a distribution system of the fiber path according to an embodiment of the present invention;

FIG. 2A is a block diagram of an optical receiver with fiber path redundancy and narrowcast operations according to an embodiment of the present invention;

FIG. 2B illustrates the flowpath of the logical commands for switching redundancy and narrowcast operations according to an embodiment of the present invention;

FIG. 3 is a flow chart of the method of sensing, monitoring and switching redundant fiber paths according to an embodiment of the present invention;

FIG. 4 is a flow chart of the switching of the narrowcast services according to an embodiment of the present invention; and

FIG. 5 is an illustrative example of a relay switch according to an embodiment of the present invention.

### DETAILED DESCRIPTION OF THE PREFERRED EMBODIMENT

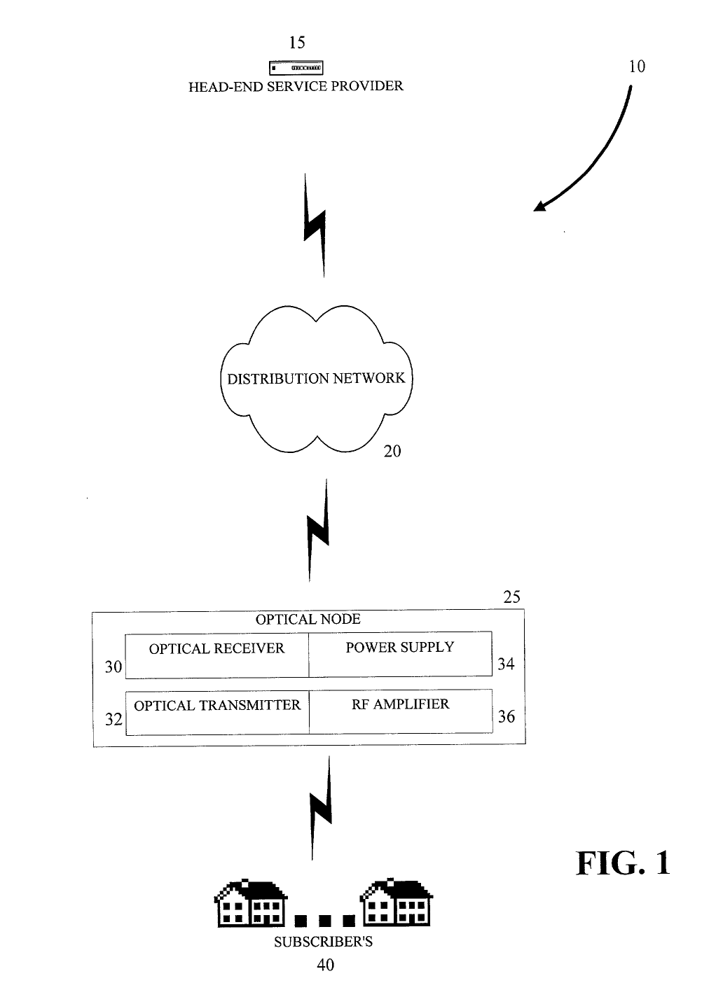

FIG. 1 illustrates a distribution system 10 of a fiber path according to an embodiment of the present invention. A head-end service provider 15 is the source of data signals that are distributed over the distribution network 20. The distribution network 20 includes fiber cables coupled to one or more optical nodes 25 configured with at least one optical receiver module 30, one optical transmitter 32, one power supply 34, and one RF amplifier 36. Optical receiver module 30 of the optical node 25 receives a data signal from the head-end service provider (via the distribution network) as modulated light signals through the fiber cable and converts the light signals to analog signals (“RF signals”). The RF signals are then sent to compatible equipment of one or more data subscribers 40 for conversion and subsequent viewing by the subscriber. The data received on the subscriber equipment typically consists of television programming, but may include other data including Internet services, telephone services, and specific subscription services referred to as narrowcast services.

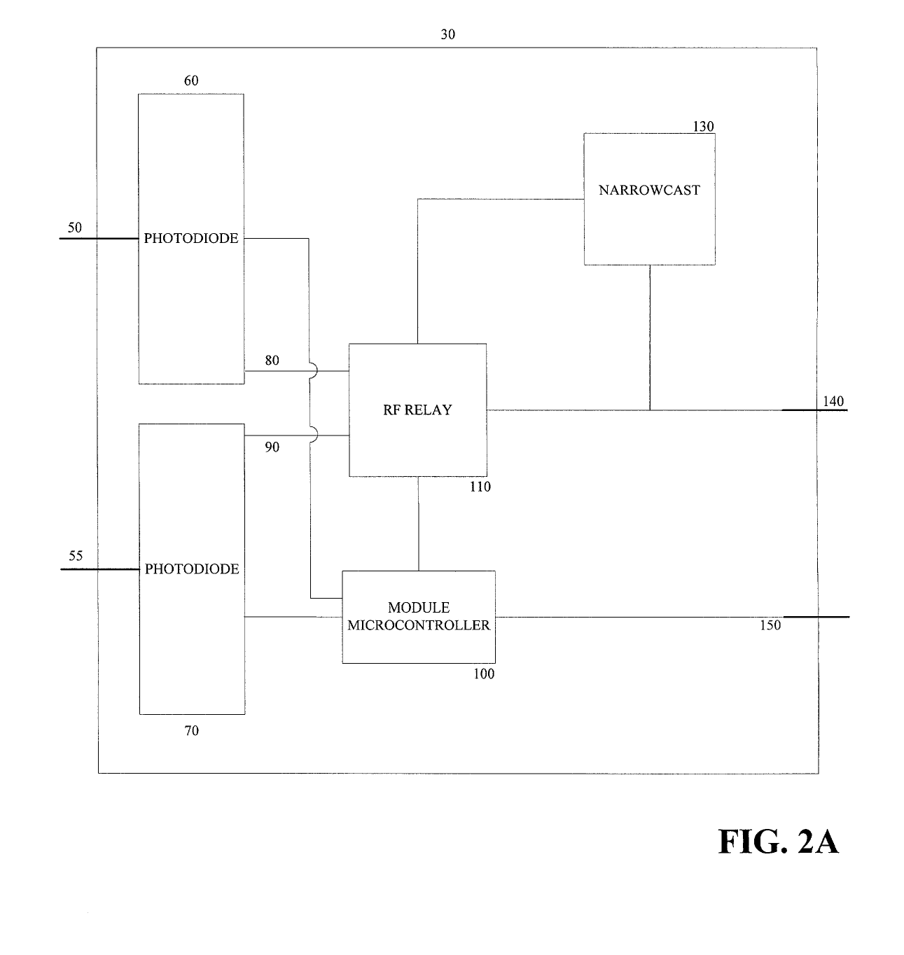

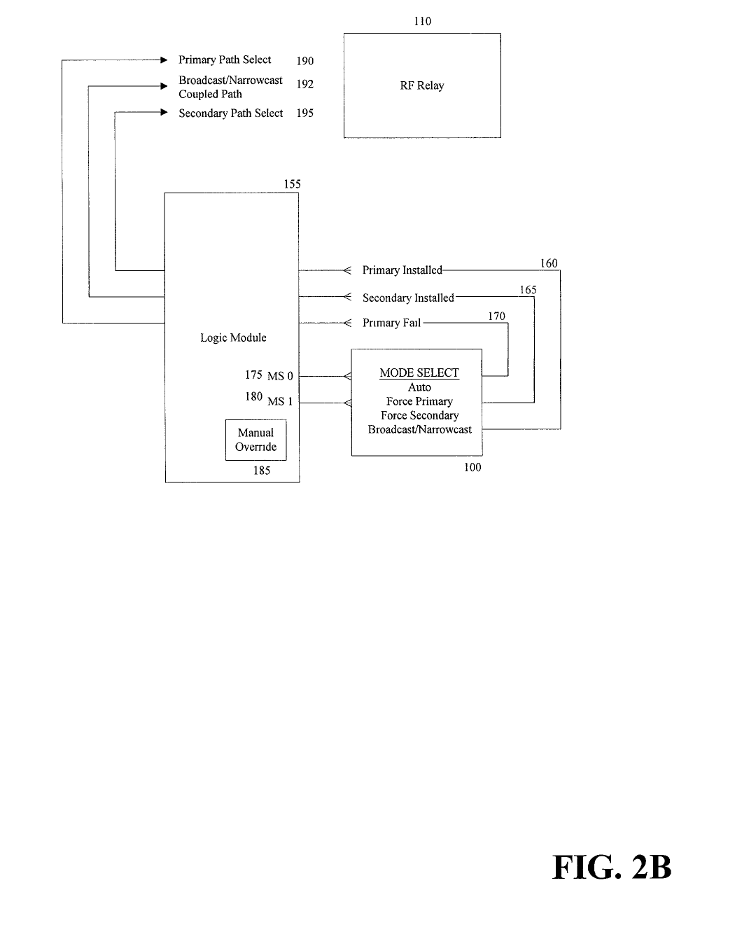

FIG. 2A is a block diagram of optical receiver module 30 with fiber path redundancy and narrowcast operations according to an embodiment of the present invention. Distribution network 20 referenced in FIG. 1 transmits an optical signal to optical receiver module 30 configured to receive the optical signal through a primary 50 and a secondary 55 optical signal path. Optical receiver module 30 includes a primary 60 and a secondary 70 photodiode that are coupled to primary 50 and secondary 60 optical signal paths. The photodiodes are coupled to an RF relay switch 110 via a primary 80 and a secondary 90 path, respectively, as well as to a module microcontroller 100. The RF relay switch 110 is further connected to narrowcast directional coupler 130. The optical receiver outputs an RF signal through an RF out path 140.

Optical receiver module 30 receives primary and/or secondary optical signals via signal paths 50 and 55 from distribution network 20. The primary and secondary photodiodes convert the primary and/or secondary optical signals to RF analog signal and send the converted RF signals over primary 80 and secondary 90 paths to switch 110. Remote control monitoring is effectuated via a system data bus 150.

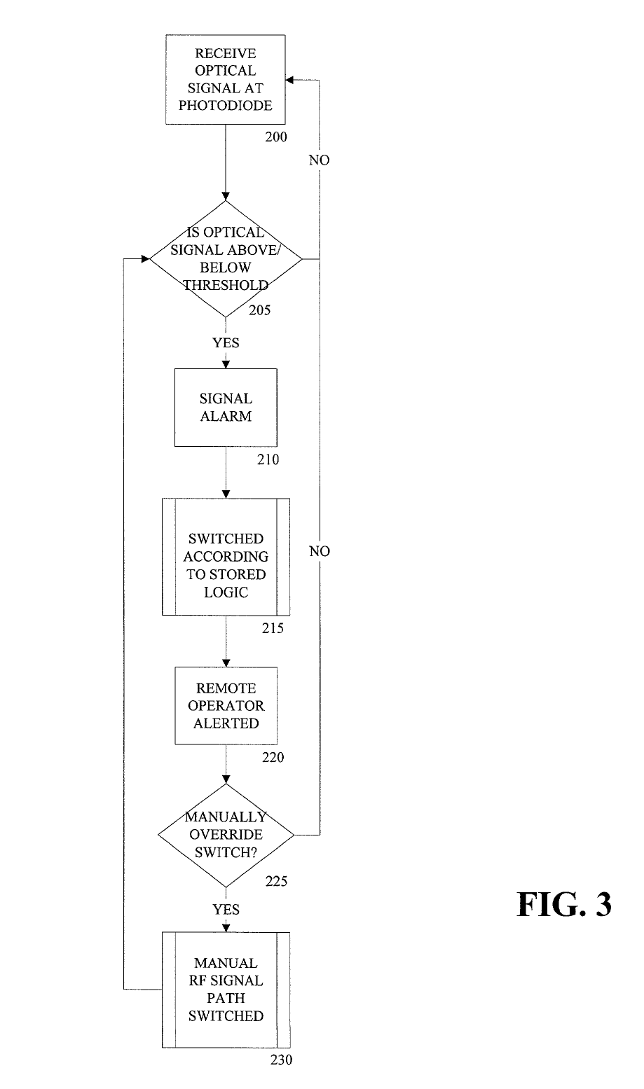

The photodiodes also send DC current values of the received optical signal to module microcontroller 100 for analysis. The monitoring and analysis functions of primary 60 and secondary 70 photodiodes and module microcontroller 100 are explained in greater detail below with reference to FIG. 3.

Module microcontroller 100 includes non-volatile storage memory and a microcontroller for storing data and controlling commands. For example, the memory stores a plurality of switching commands required for switching the RF input to the switched path (primary 80 or secondary 90), or the switch outlet through narrowcast coupler 130. The switching commands include “autoswitch” for automatically switching the switch input signal path based on default logic, “force primary” that forces RF relay switch 110 to use the signal sent on primary signal path 80, “force secondary” that forces the RF relay switch to use the signal sent on secondary signal path 90, and “narrowcast” that forces the RF relay switch to output to the narrowcast coupler 130.

The RF signal selected by switch 110 via an RF amplifier module is sent out to subscribers 40 through RF out path 140 of optical receiver module 30.

In an alternative embodiment of the invention, relay switch 110 is configured to send narrowcast services from distribution network 20 through narrowcast directional coupler 130 to subscribers 40 through RF out path 140 of the optical receiver module. The narrowcast directional coupler includes an injection point for narrowcast services in an optimum decibel range below the RF out path.

In another alternative embodiment of the invention, the functions of module microcontroller 100 are integrated into RF relay switch 110. The relay switch has a microcontroller and non-volatile storage memory for storing the data that comprise the logic and switching commands.

FIG. 2A, further with reference to FIG. 2B, illustrates a flowpath of logical commands for switching redundancy and narrowcast operations according to an embodiment of the present invention. Primary 60 and secondary 70 photodiodes are installed in optical receiver module 30. Module microcontroller 100 monitors signals of the installed primary and secondary photodiodes and a signal failure of the primary photodiode via system data bus 150 as described above. The signals from the primary and secondary photodiodes are sent via system data bus 150 along a primary installed path 160, a secondary installed path 165, or a primary fail path 170. When the module microcontroller receives the primary signal failure, the module microcontroller sends an appropriate mode select signal, either MS0 175, MS1 180 or manual override 185, to a logic module 155. The logic module sends the logical command to RF relay 110 via either a primary path select 190, a broadcast/narrowcast coupled path 192, or a secondary path select 195.

The switching logic of the redundant paths and narrowcast services is further explained with reference to the flowchart of FIG. 3. FIG. 3 is a flow chart of the method of analyzing and switching redundant fiber paths according to an embodiment of the present invention. An optical signal is received at a photodiode at block 200. At decision block 205, the DC current input of a received optical signal is tested to determine if the signal is above or below predetermined optimum input signal strength. If the current remains within the preset parameters of the optimum input signal strength, the photodiode remains in testing mode by returning to block 200.

When the data input signal is outside the optimum input signal strength range, the logic moves to block 210, where module microcontroller 100 generates an alarm signal. At block 215, the module microcontroller automatically commands RF relay switch 110 to receive the RF signal generated by the photodiode not presently being used as the source of output to subscribers 40. The automatic switching is carried out by the RF relay switch as was explained above with reference to FIG. 2A and 2B.

At block 220, the module microcontroller sends an alert signal to a remote operator via system data bus 150. At decision block 225, the remote operator decides whether to manually override the switch. If the remote operator chooses to manually override the automatic switch or to cause other operations of RF switch 110, a logical command is sent to module microcontroller 100 and the logic proceeds to block 230. At block 230, the module microcontroller then causes RF relay switch 110 to select an RF signal according to the operator's selection. If the operator does not choose to manually override the automatic switch, the RF signal path remains the preexisting path and the logic proceeds to block 200.

While the flowchart referred to in FIG. 3 illustrates a particular embodiment of sequencing, those skilled in the art will recognize that the events can occur in any sequence that allows the optical signal to be monitored and tested.

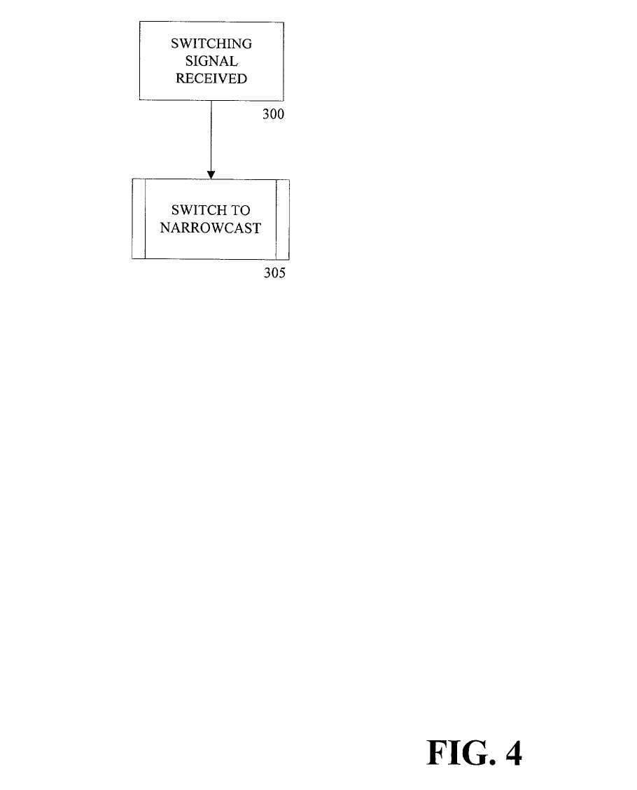

FIG. 4 is a flow chart describing the method of switching to narrowcast services according to an embodiment of the present invention. At block 300, a switching signal is received by RF relay switch 110 from a logical command sent by module microcontroller 100. At block 305, the RF relay switch causes the inputted RF signal to output according to a narrowcast services mode. The narrowcast services are distributed to subscribers of the narrowcast services through the output of narrowcast coupler 130. The switching commands for narrowcast services are optionally preconfigured through the commands stored in the memory of module microcontroller 100 or can be manually set by a remote operator in the same manner as the operator can manually override the switching of the inputted RF signal as described above with reference to FIG. 3.

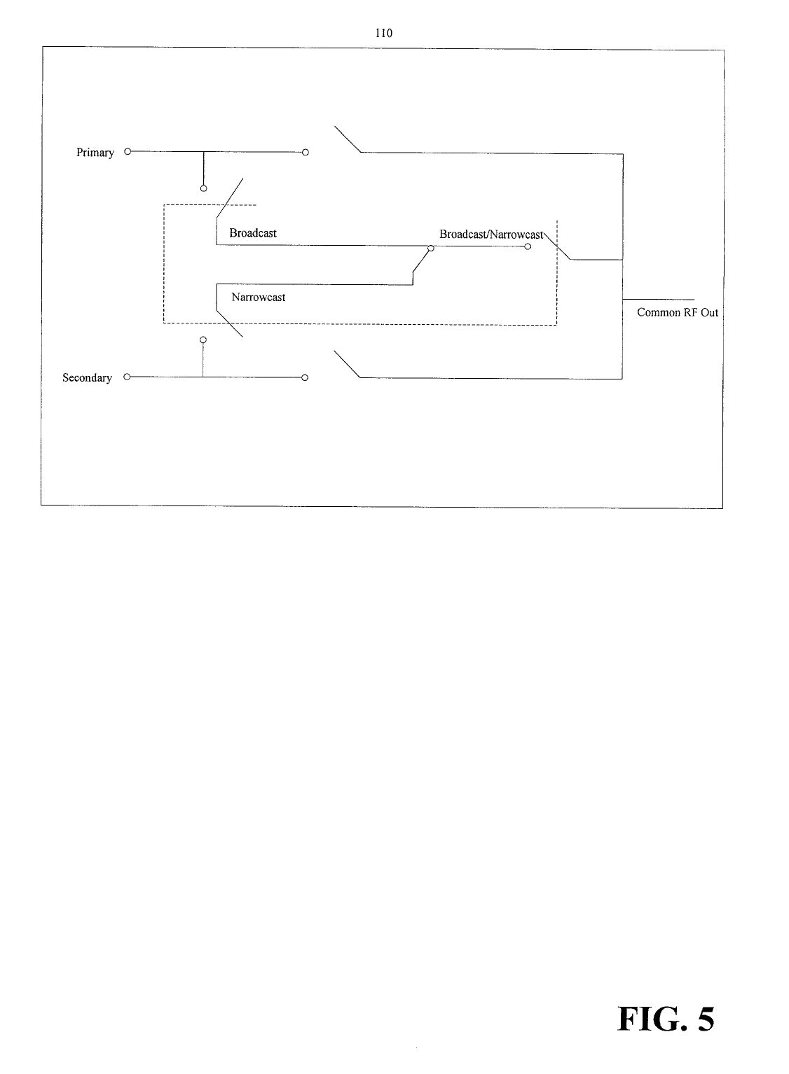

FIG. 5 is an illustrative embodiment of relay switch 110 and is further described with reference to FIGS. 2A and 2B.

While this invention has been described in terms of preferred embodiments, there are alterations, permutations, and equivalents that fall within the scope of this invention. For example, while the preferred embodiment of the system to monitor and control the optical-to-RF path is described above, the system can be implemented with a variety of permutations of the specific components identified in the preferred embodiments. Accordingly, the scope of the invention is not limited by the disclosure of the preferred embodiment. Instead, the invention should be determined entirely by reference to the claims that follow, including all such alterations, permutations, and equivalents as fall within the true spirit and scope thereof.

The embodiments of the invention in which an exclusive property or privilege is claimed are defined as follows:

1. An optical receiver for receiving a plurality of optical signals and converting the received signals into a single RF signal for delivery to subscribers, the optical receiver comprising:
a plurality of photodiodes, wherein each photodiode senses the quality of one of the received plurality of optical signals and converts the one of the received plurality of optical signals into an RF signal;
a relay switch for receiving the RF signals from the plurality of photodiodes; and
a microcontroller for controlling the relay switch according to the sensed quality of the received a plurality of optical signals.

2. The receiver of claim 1, further comprising an alert component for generating an alert signal if each of the sensed quality of the received plurality of optical signals is determined to be outside of a threshold range.

3. The receiver of claim 2, wherein the alert component is a component of at least one of the plurality of photodiodes or the microcontroller.

4. The receiver of claim 2, wherein the microcontroller comprises a communication component for sending the generated alert signal to a remote operation location over a communication network, for receiving switch control commands from the remote operation location over the communication network, and for controlling the switch based on received switch control commands.

5. The receiver of claim 4, wherein the microcontroller commands the switch to send the RF signal from one of the plurality of photodiodes to a narrowcast service path if the communication component receives a narrowcast switch command from the remote operation location over the communication network.

6. An optical receiver for receiving a plurality of optical signals and converting the received signals into a single RF signal for delivery to subscribers, the optical receiver comprising:
a plurality of photodiodes, wherein each photodiode senses the quality of one of the received plurality of optical signals and converts the one of the received plurality of optical signals into an RF signal;
a relay switch for receiving the RF signals from the plurality of photodiodes;
a microcontroller for controlling the relay switch according to the sensed quality of the received a plurality of optical signals; and
an alert component for generating an alert signal if each of the sensed quality of the received plurality of optical signals is determined to be outside of a threshold range.

7. The receiver of claim 6, wherein the alert component is a component of at least one of the plurality of photodiodes or the microcontroller.

8. The receiver of claim 6, wherein the microcontroller comprises a communication component for sending the generated alert signal to a remote operation location over a communication network, for receiving switch control commands from the remote operation location over the communication network, and for controlling the switch based on received switch control commands.

9. The receiver of claim 8, wherein the microcontroller commands the switch to send the RF signal from one of the plurality of photodiodes to a narrowcast service path if the communication component receives a narrowcast switch command from the remote operation location over the communication network.

10. An optical receiver for receiving a plurality of optical signals and converting the received signals into a single RF signal for delivery to subscribers, the optical receiver comprising:
a plurality of photodiodes, wherein each photodiode senses the quality of one of the received plurality of optical signals and converts the one of the received plurality of optical signals into an RF signal;
a relay switch for receiving the RF signals from the plurality of photodiodes;
a microcontroller for controlling the relay switch according to the sensed quality of the received a plurality of optical signals, wherein the microcontroller comprises a communication component for sending the generated alert signal to a remote operation location over a communication network, for receiving switch control commands from the remote operation location over the communication network, and for controlling the switch based on received switch control commands.; and
an alert component for generating an alert signal if each of the sensed quality of the received plurality of optical signals is determined to be outside of a threshold range, whereby the alert component is a component of at least one of the plurality of photodiodes or the microcontroller.

11. The receiver of claim 10, wherein the microcontroller commands the switch to send the RF signal from one of the plurality of photodiodes to a narrowcast service path if the communication component receives a narrowcast switch command from the remote operation location over the communication network.
